(19) United States
(12) Patent Application Publication
(10) Pub. No.: US 2010/0101713 A1
(43) Pub. Date: Apr. 29, 2010

(54) PRINTING MOLD AND MANUFACTURING METHOD THEREOF, AND METHOD OF FORMING THIN FILM PATTERN USING THE SAME

(75) Inventors: Kyu-Young KIM, Suwon-si (KR); Jae-Hyuk Chang, Seongnam-si (KR); Dae-Jin Park, Incheon (KR); Ju-Han Bae, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/400,492

(22) Filed: Mar. 9, 2009

(30) Foreign Application Priority Data
Oct. 28, 2008 (KR) 10-2008-0105791

(51) Int. Cl. B29C 59/02; B28B 7/36

(52) U.S. Cl. 156/232; 425/89

(57) ABSTRACT

Disclosed are a printing mold and a manufacturing method thereof, and a method of forming a thin film pattern using the printing mold. The printing mold comprises a polymer-based main body with convex and concave surface portions, and an ink-phobic layer disposed on the concave surface portions of the main body.

### CROSS-REFERENCE TO RELATED APPLICATION

This application claims priority from and the benefit of Korean Patent Application No. 10-2008-0105791 filed on Oct. 28, 2008, which is hereby incorporated by reference for all purposes as if fully set forth herein.

### BACKGROUND OF THE INVENTION

1. Field of the Invention

The present invention relates to a printing mold and a manufacturing method thereof, and a method of forming a thin film pattern using the same.

2. Discussion of the Background

A photolithography process is widely used to create a display device and an electronic device. However, the photolithography process requires expensive exposure equipment and an expensive mask, resulting in increased initial investment costs and reduced economic effectiveness. Moreover, there is a limit in forming an ultra-micro pattern using the photolithography process.

Accordingly, non-mask inkjet printing, gravure printing, offset printing, screen printing, and nano-imprinting techniques have become more desirable, and with the inkjet printing technique in particular, color filters have become commercially significant.

Alternative techniques to photolithography each have merits and drawbacks. For example, inkjet printing provides the advantage of reduced material cost and simplified processing steps but also has the drawback of poor resolution, while roll printing presents the drawbacks of poor resolution and difficult alignment. Nano-imprinting has the advantage of high nanometer-scaled resolution in forming an ultra-micro pattern, but has the drawbacks of poor uniformity and particle properties, and a long processing time since it requires a contact process.

### SUMMARY OF THE INVENTION

The present invention provides a printing device and a method of forming a pattern using the same.

Additional features of the invention will be set forth in the description which follow, and in part will be apparent from the description or may be learned by the practice of the invention.

The present invention discloses a printing mold comprising a polymer-based main body comprising convex and concave surface portions, and an ink-phobic layer disposed on the concave surface portion of the main body wherein the ink-phobic layer may comprise a hydrophobic surface; and the ink-phobic layer may comprise at least one material selected from a group comprising n-octadecyltrimethoxysilane (ODS), octadecyltrichlorosilane (OTS), and heptadecafluoro-1,1,2,2-tetrahydrodecyl-1-trimethoxysilane (FAS).

The present invention also discloses a printing mold comprising a substrate, an ink-phobic layer disposed on a surface of the substrate, and an ink-philic layer disposed on a portion of the ink-phobic layer wherein the ink-phobic layer may comprise at least one material selected from a group comprising n-octadecyltrimethoxysilane (ODS), octadecyltrichlorosilane (OTS), and heptadecafluoro-1,1,2,2-tetrahydrodecyl-1-trimethoxysilane (FAS) and the ink-philic layer may comprise a material selected from a group comprising silicon, silicon oxide, silicon nitride, a metal, a metal oxide, and a metal nitride.

The present invention also discloses a polymer-based main body comprising convex and concave surface portions, an ink-phobic layer disposed on the concave surface portions of the main body, and an ink-philic layer disposed on the convex surface portions of the main body.

The present invention also discloses a method of forming a thin film pattern using a printing mold. The method comprises coating a substrate-coating layer comprising a hydrophobic polymer film onto a first substrate, forming an ink layer comprising a first portion and a second portion on the substrate-coating layer, arranging a mold over the ink layer, the mold comprising a convex portion, a concave portion, and an ink-phobic layer disposed a surface of the concave portion, contacting the convex portion of the mold with the first portion of the ink layer, separating the mold and the ink layer from each other to transfer the first portion of the ink layer onto the convex portion of the mold, and re-transferring the transferred first portion onto a second substrate.

### BRIEF DESCRIPTION OF THE DRAWINGS

FIG. 1 is a cross-sectional view of a printing mold according to a first exemplary embodiment of the present invention.

FIG. 2 is a cross-sectional view of a printing mold according to a second exemplary embodiment of the present invention.

FIG. 3A, FIG. 3B, FIG. 3C, FIG. 3D, and FIG. 3E are cross-sectional views sequentially illustrating a printing process using a printing mold according to a first exemplary embodiment of the present invention.

FIG. 4A, FIG. 4B, and FIG. 4C are cross-sectional views sequentially illustrating another printing process using a printing mold according to a first exemplary embodiment of the present invention.

FIG. 5A, FIG. 5B, FIG. 5C, and FIG. 5D are cross-sectional views sequentially illustrating a printing process using a printing mold according to a second exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. This invention may, however, be embodied in many different forms and should not be construed as limited to the embodiments set forth herein. Rather these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

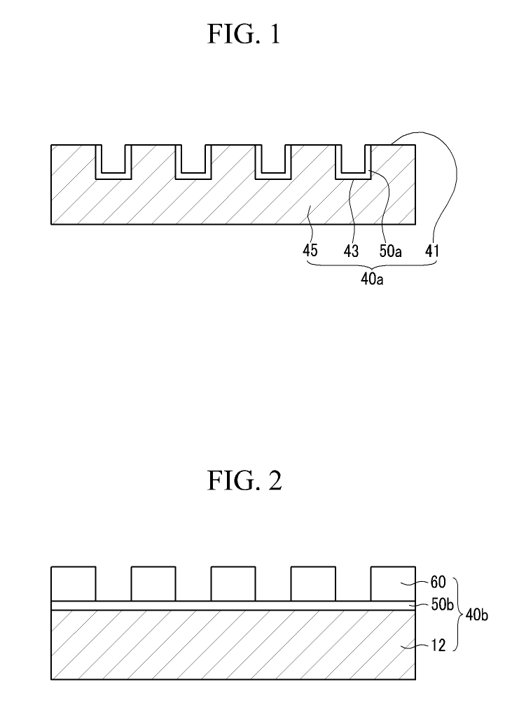

A printing mold and a manufacturing method thereof according to a first exemplary embodiment of the present invention will now be described with reference to FIG. 1.

Referring to FIG. 1, a printing mold 40a according to a first exemplary embodiment of the present invention includes a polymer-based main body 45 with convex surface portions 41 and concave surface portions 43, and an ink-phobic layer 50a formed on the concave surface portions 43. The ink-phobic layer 50a has a hydrophobic surface with a contact angle of 100 degrees or more, and may be formed with at least one material selected from a group comprising n-octadecyltrimethoxysilane (ODS), octadecyltrichlorosilane (OTS), and heptadecafluoro-1,1,2,2-tetrahydrodecyl-1-trimethoxysilane (FAS).

Alternatively, in the embodiment described above, an ink-philic layer comprised of one of silicon, silicon oxide, silicon nitride, a metal, a metal oxide, and a metal nitride may also be disposed on convex surface portions 41.

A method of manufacturing a printing mold 40a according to a first exemplary embodiment will now be described in detail.

A polymer-based main body 45 with convex surface portions 41 and concave surface portions 43 is prepared, and the concave portions 43 of the main body 45 are surface-treated so as to form an ink-phobic layer 50a thereon as a self-assembly monolayer (SAM). The surface treatment for forming the SAM layer may be made with a material selected from a group comprising n-octadecyltrimethoxysilane (ODS), octadecyltrichlorosilane (OTS), and heptadecafluoro-1,1,2,2-tetrahydrodecyl-1-trimethoxysilane (FAS).

In conjunction with the formation of the SAM layer, the SAM is applied to the surface of the main body 45. Portions of the SAM on the convex surface portions 41 of the main body are removed by transferring them onto a sacrificial substrate wherein portions of the SAM on the concave surface portion 43 of the main body 45 are retained. This remaining SAM material on the concave surface portion 43, performs a self-assembly so that it chemically bonds with the concave surface portion 43 to thereby form a mono-layered thin film, which thereafter bonds with other layers through a physical bond and grows into a multi-layered thin film. The concave portion 43 and the SAM material directly disposed thereon chemically bond with each other to create a very strong bond. By contrast, the multiple layers grown on the SAM layer through the physical bonding form a relatively weak bond. Accordingly, when the concave surface portion 43 is cleaned by way of a solvent such as isopropyl alcohol, the multiple layers connected thereto through the physical bonding are easily broken. As a result, the SAM layer is formed only on the concave portion of the main body 43.

A printing mold and a manufacturing method thereof according to a second exemplary embodiment of the present invention will now be explained with reference to FIG. 2.

Referring to FIG. 2, a printing mold 40b according to a second exemplary embodiment of the present invention includes a substrate 12, an ink-phobic layer 50b formed on the surface of the substrate 12, and an ink-philic layer 60 partially formed on the ink-phobic layer 50b. The ink-phobic layer 50b may be formed with at least one material selected from polydimethylsiloxane (PDMS), n-octadecyltrimethoxysilane (ODS), octadecyltrichlorosilane (OTS), and heptadecafluoro-1,1,2,2-tetrahydrodecyl-1-trimethoxysilane (FAS). The ink-philic layer 60 is partially formed on a portion of the ink-phobic layer 50b with any one material selected from a group comprising silicon, silicon oxide, silicon nitride, a metal, a metal oxide, and a metal nitride.

A method of manufacturing a printing mold 40b according to a second exemplary embodiment of the present invention will now be described in detail.

A substrate 12 is prepared, and an ink-phobic layer 50b is formed on the substrate 12 by applying any one material selected from a group comprising polydimethylsiloxane (PDMS), n-octadecyltrimethoxysilane (ODS), octadecyltrichlorosilane (OTS), and heptadecafluoro-1,1,2,2-tetrahydrodecyl-1-trimethoxysilane (FAS). An ink-philic layer 60 is formed on a portion of the ink-phobic layer 50b by applying any one material selected from the group comprising silicon, silicon oxide, silicon nitride, a metal, a metal oxide, and a metal nitride.

The ink-phobic layer 50b may be easily formed though coating or depositing the above material on the surface of the substrate 12 by way of a common spin coater or various kinds of deposition apparatuses. The ink-philic layer 60 partially formed on the ink-phobic layer 50b may be made in the following manner:

A film for an ink-philic layer is first coated on the surface of the ink-phobic layer 50b applied on the substrate 12, and a resist film is coated thereon. The resist film is then exposed to light using a patterning photo-mask. Thereafter, the resist film is developed to thereby form a resist pattern. Finally, the film for the ink-philic layer 60 is etched using the resist pattern as a mask.

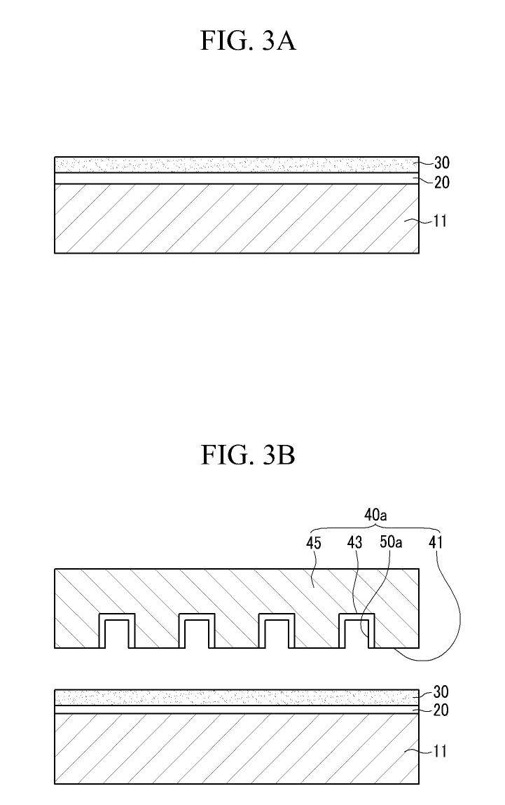

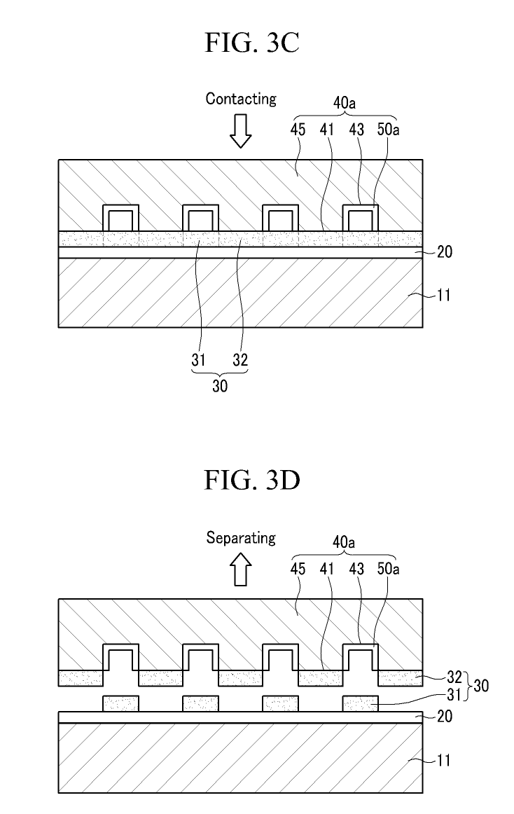

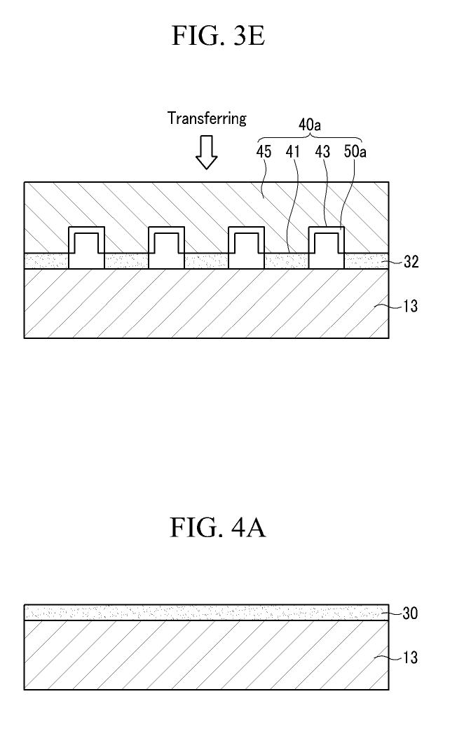

A method of forming a thin film pattern using the printing mold according to the first exemplary embodiment of the present invention will now be described with reference to FIG. 3A, FIG. 3B, FIG. 3C, FIG. 3D and FIG. 3E.

As shown in FIG. 3A, a substrate-coating layer 20 containing a hydrophobic polymer film, and an ink layer 30 are sequentially formed on a first substrate 11. The ink layer 30 may be formed with a material selected from a group comprising a metallic ink containing Ag or Cu, an Indium Gallium Zinc Oxide (IGZO) solution, a semiconductor material containing pentacene, a Si solution, an ITO slurry, or a carbon nanotube dispersion, and the hydrophobic polymer film may comprise at least one of polydimethylsiloxane (PDMS) and a fluorine-containing film, and Teflon®. Thereafter, as shown in FIG. 3B, the printing mold 40a manufactured according to the first exemplary embodiment is arranged over the ink layer 30, and as shown in FIG. 3C, the convex portions 41 of the printing mold 40a make contact with first portions 32 of the ink layer 30. As shown in FIG. 3D, the printing mold 40a and the ink layer 30 are separated from each other so as to transfer the first portions 32 of the ink layer 30 onto the convex portions 41 of the printing mold 40a. Finally, as shown in FIG. 3E, the first portions 32 of the ink layer 30 transferred onto the convex portions 41 are re-transferred onto a pattern formation substrate 13. With the interrelation in surface energy dimension of the substrate 11 coated with a substrate-coating layer 20, the ink layer 30, and the convex portions 41 of the printing mold 40a, the substrate 11 has the lowest surface energy, and the convex portions 41 have the highest surface energy, while the surface energy of the ink layer 30 is intermediate between them. Accordingly, the first portions 32 of the ink layer 30 can be transferred onto the convex surface portions 41 of the printing mold 40a having a relatively high surface energy.

Meanwhile, a first adhesive layer may be further formed on the pattern formation substrate 13 so as to make it easier to re-transfer the first portions 32 of the ink layer 30 from the convex surface portions 41 of the printing mold 40a onto the pattern formation substrate 13. Furthermore, instead of forming a first adhesive layer on the pattern formation substrate 13, a second adhesive layer may be further formed on the first surface portions of the ink layer 30 before the re-transferring step. The formation of the second adhesive layer on the first portions 32 of the ink layer 30 also makes it easier to conduct the re-transferring. The material that is available as the first and second adhesive layers includes a terminal group comprising a thiol group (—SH) so as to make a chemical bond with an ink containing a metallic component such as silver and another terminal group comprising at least one of a silane group and a substituted silane group so as to improve adhesiveness with a glass-based substrate.

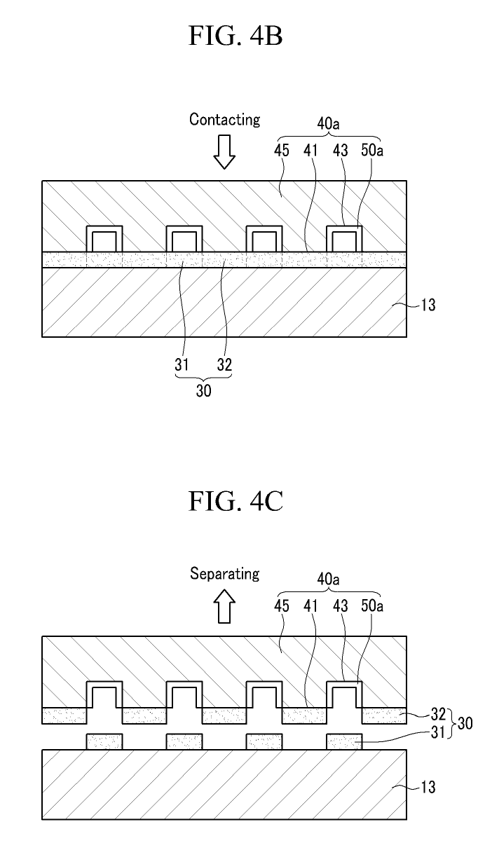

Another method of forming a thin film pattern using the printing mold 40a according to the first exemplary embodiment of the present invention will now be described with reference to FIG. 4A to FIG. 4C and in comparison with that according to the third exemplary embodiment, based on different contents from those related to the third exemplary embodiment.

As shown in FIG. 4A, an ink layer 30 is coated onto a pattern formation substrate 13. Thereafter, as shown in FIG. 4B, the printing mold 40a according to the first exemplary embodiment of the present invention, which has convex portions 41, concave portions 43 coated with an ink-phobic layer 50a, and a main body 45, is arranged over the pattern formation substrate 13, and then the convex portions 41 of the printing mold 40a make contact with unpatterned portions 32 of the ink layer 30. As shown in FIG. 4C, the printing mold 40a and the ink layer 30 are separated from each other so as to transfer the unpatterned portions 32 onto the convex portions 41. As a result, only the patterning portions 31 required for forming the desired pattern are left on the pattern formation substrate 13. In order for the ink to maintain adherence to the mold 40a, the ink layer 30 formed on the pattern formation substrate 13 may be in a solid state rather than a liquid state, that is, in a state where only the solvent component thereof is vaporized so that it is semi-dried, but not sintered. Accordingly, it may be required to conduct heat treatment at a temperature that is sufficiently high to vaporize the solvent contained in the ink layer 30.

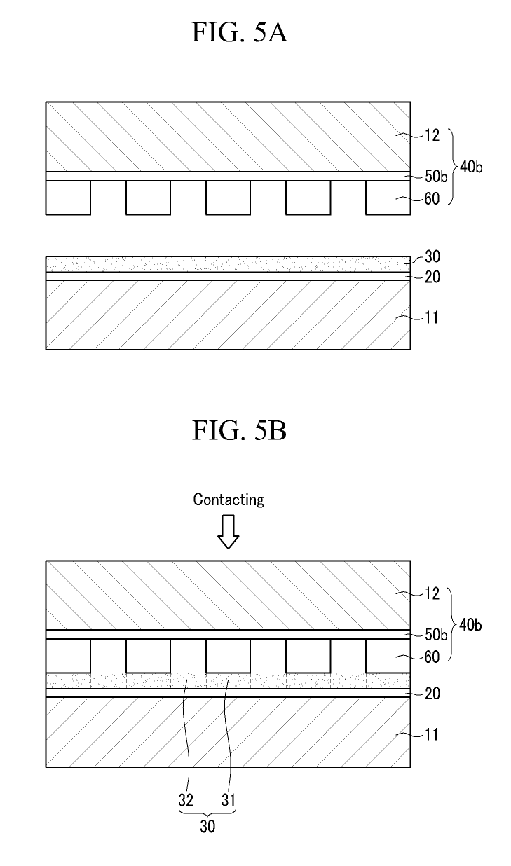

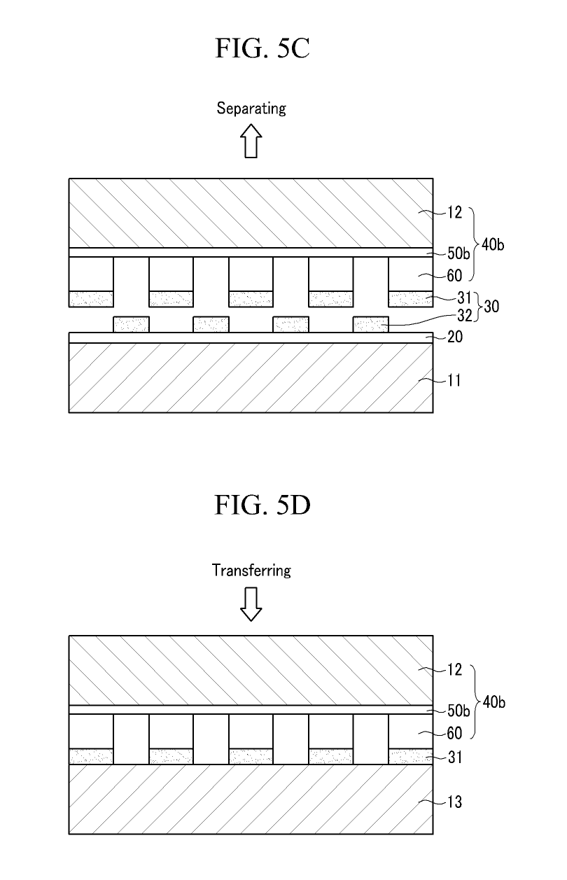

A method of forming a thin film pattern using the printing mold according to the second exemplary embodiment will now be described with reference to FIG. 5A to FIG. 5D, and in comparison with that according to the third exemplary embodiment, based on different contents from those related to the third exemplary embodiment.

As shown in FIG. 5A, a substrate-coating layer 20 comprising a hydrophobic polymer film, and an ink layer 30 comprising first and second portions, are sequentially formed on the first substrate 11 to thereby make a first substrate unit. Thereafter, as shown in FIG. 5B, the printing mold 40b manufactured according to the second exemplary embodiment is mounted over the ink layer 30, and the ink-philic layer 60 makes contact with the first portions 31 of the ink layer 30. As shown in FIG. 5C, the printing mold 40b and the ink layer 30 are separated from each other so as to transfer the first portions 31 of the ink layer 30 onto the ink-philic layer 60 of the mold 40b. With the interrelation in surface energy dimension of the substrate 11, the ink layer 30, and the ink-philic layer 60 of the mold 40b, the substrate 11 has the lowest surface energy, and the ink-philic layer 60 has the highest surface energy, while the surface energy of the ink layer 30 mediates between them. Accordingly, the patterning portions 31 of the ink layer 30 can be transferred onto the surface of the ink-philic layer 60 of the mold 40b having a relatively high surface energy. Then, as shown in FIG. 5D, the patterning portions 31 of the ink layer 30 transferred onto the ink-philic layer 60 of the mold 40b are re-transferred onto a pattern formation substrate 13.

When a printing mold according to an exemplary embodiment of the present invention is used in a printing process, the efficiency of the printing process may be improved through a simple mold surface treatment process at low cost.

It will be apparent to those skilled in the art that various modifications and variations can be made in the present invention without departing from the spirit or scope of the invention. Thus it is intended that the present invention cover the modifications and variations of this invention provided they come within the scope of the appended claims and their equivalents.

What is claimed is:

1. A printing mold comprising:
a polymer-based main body comprising convex surface portions and concave surface portions; and
an ink-phobic layer disposed on the concave surface portions of the main body.

2. The printing mold of claim 1, wherein the ink-phobic layer comprises a hydrophobic surface.

3. The printing mold of claim 2, wherein the ink-phobic layer comprises at least one of n-octadecyltrimethoxysilane (ODS), octadecyltrichlorosilane (OTS), and heptadecafluoro-1,1,2,2-tetrahydrodecyl-1-trimethoxysilane (FAS).

4. A printing mold comprising:
a substrate;
an ink-phobic layer disposed on a surface of the substrate; and
an ink-philic layer disposed on a portion of the ink-phobic layer.

5. The printing mold of claim 4, wherein the ink-phobic layer comprises at least one of n-octadecyltrimethoxysilane (ODS), octadecyltrichlorosilane (OTS), and heptadecafluoro-1,1,2,2-tetrahydrodecyl-1-trimethoxysilane (FAS).

6. The printing mold of claim 4, wherein the ink-philic layer comprises at least one of silicon, silicon oxide, silicon nitride, a metal, a metal oxide, and a metal nitride.

7. A printing mold, comprising:
a polymer-based main body comprising convex surface portions and concave surface portions;
an ink-phobic layer disposed on the concave surface portions of the main body; and
an ink-philic layer disposed on the convex surface portions of the main body.

8. A method of forming a thin film pattern using a printing mold, the method comprising:
coating a substrate-coating layer comprising a hydrophobic polymer film on a first substrate;
forming an ink layer comprising a first portion and a second portion on the substrate-coating layer;
arranging a mold over the ink layer, the mold comprising a convex portion, a concave portion, and an ink-phobic layer disposed on a surface of the concave portion;
contacting the convex portion of the mold with the first portion of the ink layer;
separating the mold and the ink layer from each other, thereby transferring the first portion of the ink layer onto the convex portion of the mold; and
re-transferring the transferred first portion of the ink layer onto a second substrate.

9. The method of claim 8, wherein the ink-phobic layer comprises a hydrophobic surface.

10. The method of claim 9, wherein the ink-phobic layer comprises at least one of n-octadecyltrimethoxysilane (ODS), octadecyltrichlorosilane (OTS), and heptadecafluoro-1,1,2,2-tetrahydrodecyl-1-trimethoxysilane (FAS).

11. The method of claim 10, wherein the ink layer comprises at least one of a metallic ink containing Ag or Cu, an IGZO solution, a semiconductor material containing pentacene, a Si solution, an ITO slurry, and a carbon nanotube dispersion.

12. The method of claim 11, wherein the hydrophobic polymer film comprises at least one of polydimethylsiloxane (PDMS) and a fluorine-containing film.

13. The method of claim 12, wherein the fluorine-containing film comprises a Teflon® film.

14. The method of claim 13, wherein a surface energy of the substrate-coating layer, a surface energy of the ink layer, and a surface energy of the convex portion of the mold increase in that order.

15. The method of claim 14, further comprising forming a first adhesive layer on the second substrate.

16. The method of claim 15, further comprising forming a second adhesive layer on a surface of the first portion before the re-transferring.
